(19) United States
(12) Patent Application Publication
(10) Pub. No.: US 2022/0399956 A1
(43) Pub. Date: Dec. 15, 2022

(54) ERROR VECTOR MAGNITUDE REQUIREMENT UPDATES

(71) Applicant: QUALCOMM Incorporated, San Diego, CA (US)

(72) Inventors: Naeem AKL, Somerville, NJ (US); Tao LUO, San Diego, CA (US); Jianghong LUO, Skillman, NJ (US); Navid ABEDINI, Basking Ridge, NJ (US); Junyi LI, Fairless Hills, PA (US)

(21) Appl. No.: 17/806,667

(22) Filed: Jun. 13, 2022

Related U.S. Application Data
(60) Provisional application No. 63/202,503, filed on Jun. 14, 2021.

(51) Int. Cl. H04L 1/00; H04L 1/04; H04L 1/06; H04L 43/065; H04L 43/067

(52) U.S. Cl. CPC H04L 1/0046; H04L 1/04; H04L 1/0618; H04L 43/065; H04L 43/067

(57) ABSTRACT

Various aspects of the present disclosure generally relate to wireless communication. In some aspects, a transmitting device may communicate an indication of an updated error vector magnitude (EVM) requirement. The transmitting device may transmit a communication using transmit processing associated with the updated EVM requirement. Numerous other aspects are described.

### CROSS-REFERENCE TO RELATED APPLICATION

This Patent Application claims priority to U.S. Provisional Patent Application No. 63/202,503, filed on Jun. 14, 2021, entitled “ERROR VECTOR MAGNITUDE REQUIREMENT UPDATES,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for error vector magnitude requirement updates.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a transmitting device. The method may include communicating an indication of an updated error vector magnitude (EVM) requirement. The method may include transmitting a communication using transmit processing associated with the updated EVM requirement.

Some aspects described herein relate to a method of wireless communication performed by a receiving device. The method may include communicating an indication of an updated EVM requirement. The method may include receiving a communication based at least in part on the updated EVM requirement.

Some aspects described herein relate to a transmitting device for wireless communication. The transmitting device may include a memory and one or more processors coupled to the memory. The one or more processors may be configured to communicate an indication of an updated EVM requirement. The one or more processors may be configured to transmit a communication using transmit processing associated with the updated EVM requirement.

Some aspects described herein relate to a receiving device for wireless communication. The receiving device may include a memory and one or more processors coupled to the memory. The one or more processors may be configured to communicate an indication of an updated EVM requirement. The one or more processors may be configured to receive a communication based at least in part on the updated EVM requirement.

Some aspects described herein relate to a non-transitory computer-readable medium that stores a set of instructions for wireless communication by a transmitting device. The set of instructions, when executed by one or more processors of the transmitting device, may cause the transmitting device to communicate an indication of an updated EVM requirement. The set of instructions, when executed by one or more processors of the transmitting device, may cause the transmitting device to transmit a communication using transmit processing associated with the updated EVM requirement.

Some aspects described herein relate to a non-transitory computer-readable medium that stores a set of instructions for wireless communication by a receiving device. The set of instructions, when executed by one or more processors of the receiving device, may cause the receiving device to communicate an indication of an updated EVM requirement. The set of instructions, when executed by one or more processors of the receiving device, may cause the receiving device to receive a communication based at least in part on the updated EVM requirement.

Some aspects described herein relate to an apparatus for wireless communication. The apparatus may include means for communicating an indication of an updated EVM requirement. The apparatus may include means for transmitting a communication using transmit processing associated with the updated EVM requirement.

Some aspects described herein relate to an apparatus for wireless communication. The apparatus may include means for communicating an indication of an updated EVM requirement. The apparatus may include means for receiving a communication based at least in part on the updated EVM requirement.

Aspects generally include a method, apparatus, system, computer program product, non-transitory computer-readable medium, user equipment, base station, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of communicating based at least in part on an error vector magnitude (EVM) requirement, in accordance with the present disclosure.

FIGS. 4 and 5 are diagrams illustrating examples associated with EVM requirement updates, in accordance with the present disclosure.

FIGS. 6 and 7 are diagrams illustrating example processes associated with EVM requirement updates, in accordance with the present disclosure.

FIGS. 8 and 9 are diagrams of example apparatuses for wireless communication, in accordance with the present disclosure.

FIG. 10 is a diagram illustrating an example of an open radio access network (O-RAN) architecture, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

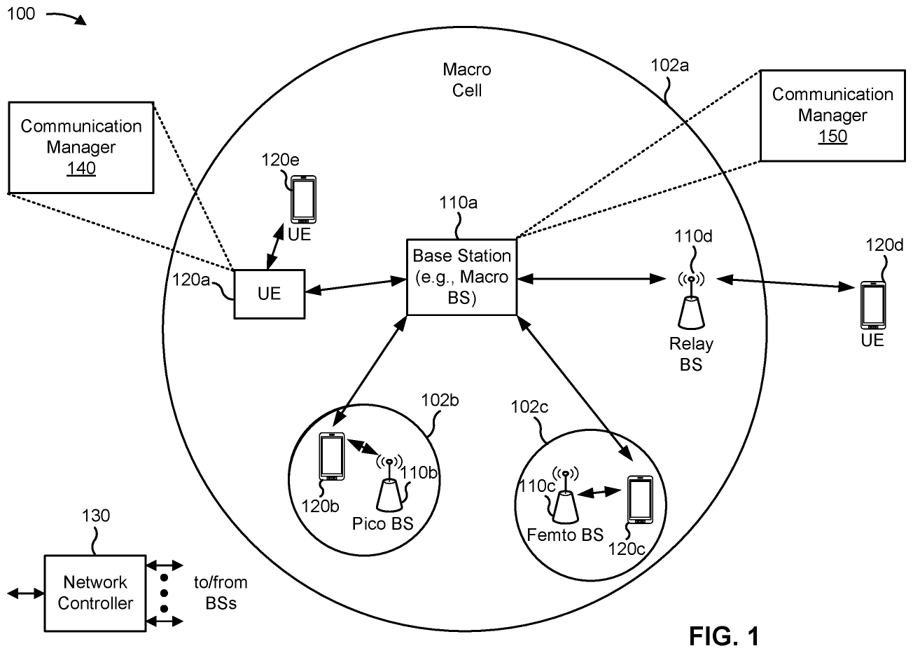

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the transmitting device may include a communication manager 140 or 150. As described in more detail elsewhere herein, the communication manager 140 or 150 may communicate an indication of an updated EVM requirement; and transmit a communication using transmit processing associated with the updated EVM requirement. Additionally, or alternatively, the communication manager 140 or 150 may perform one or more other operations described herein.

In some aspects, the receiving device may include a communication manager 140 or 150. As described in more detail elsewhere herein, the communication manager 140 or 150 may communicate an indication of an updated EVM requirement; and receive a communication based at least in part on the updated EVM requirement. Additionally, or alternatively, the communication manager 140 or 150 may perform one or more other operations described herein.

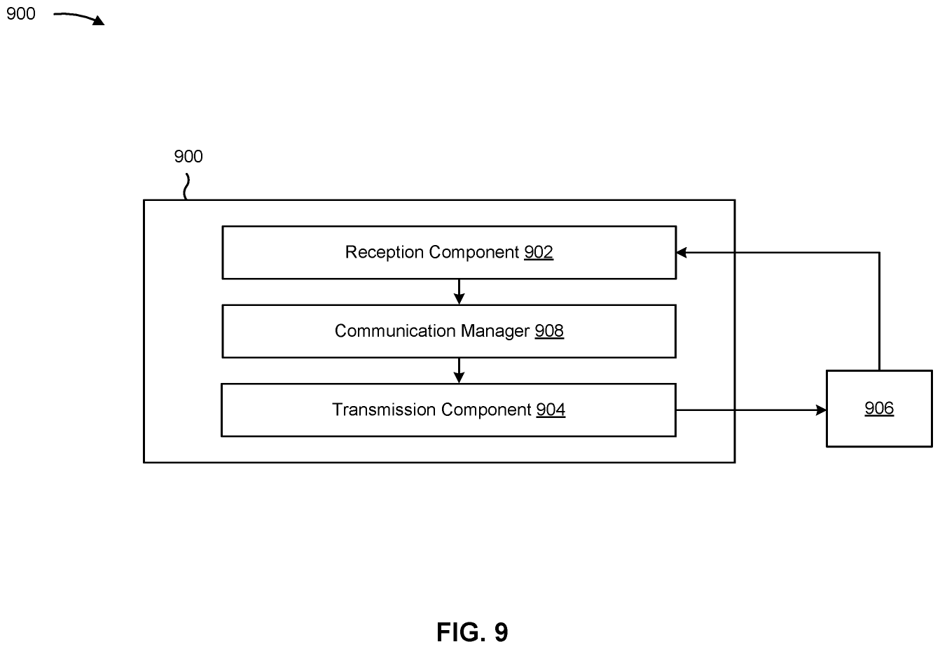

In some aspects, the term “base station” (e.g., the base station 110) or “network node” or “network entity” may refer to an aggregated base station, a disaggregated base station (e.g., described in connection with FIG. 9), an integrated access and backhaul (IAB) node, a relay node, and/or one or more components thereof. For example, in some aspects, “base station,” “network node,” or “network entity” may refer to a central unit (CU), a distributed unit (DU), a radio unit (RU), a Near-Real Time (Near-RT) radio access network (RAN) Intelligent Controller (RIC), or a Non-Real Time (Non-RT) MC, or a combination thereof In some aspects, the term “base station,” “network node,” or “network entity” may refer to one device configured to perform one or more functions, such as those described herein in connection with the base station 110. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station,” “network node,” or “network entity” may refer to one of the base station functions and not another. In this way, a single device may include more than one base station.

As indicated above, FIG. 1 is provided as an example. Other examples may differ from what is described with regard to FIG. 1.

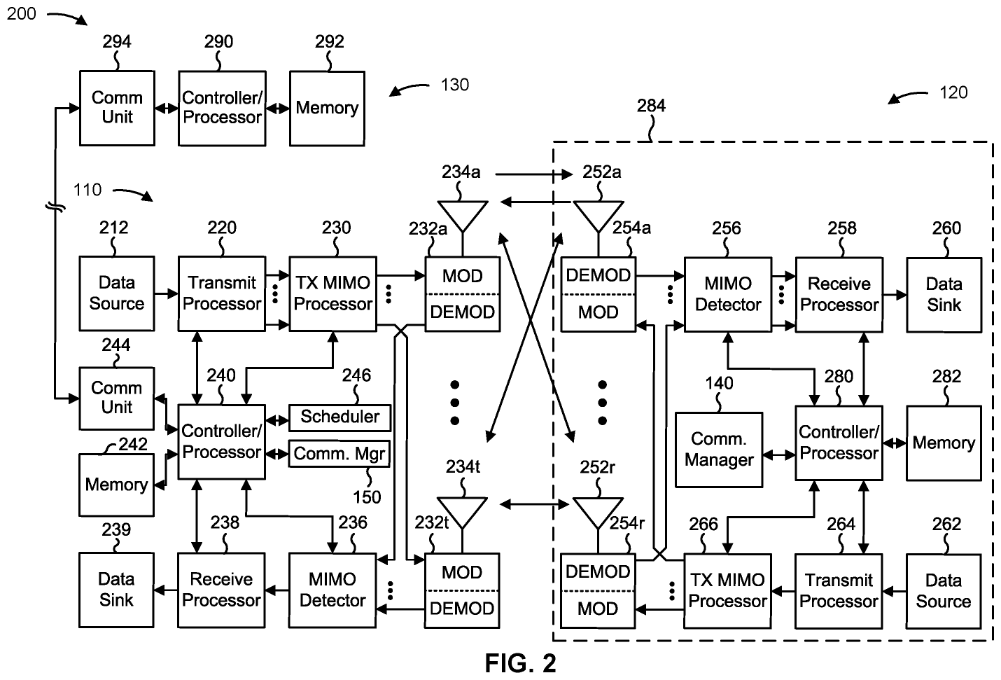

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

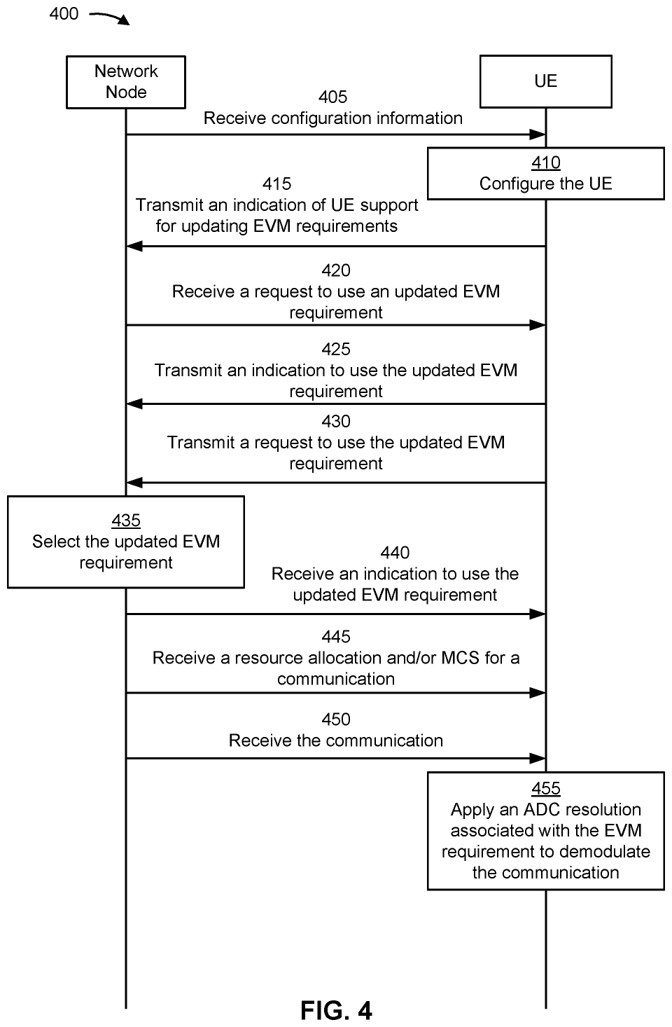

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-9).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-9).

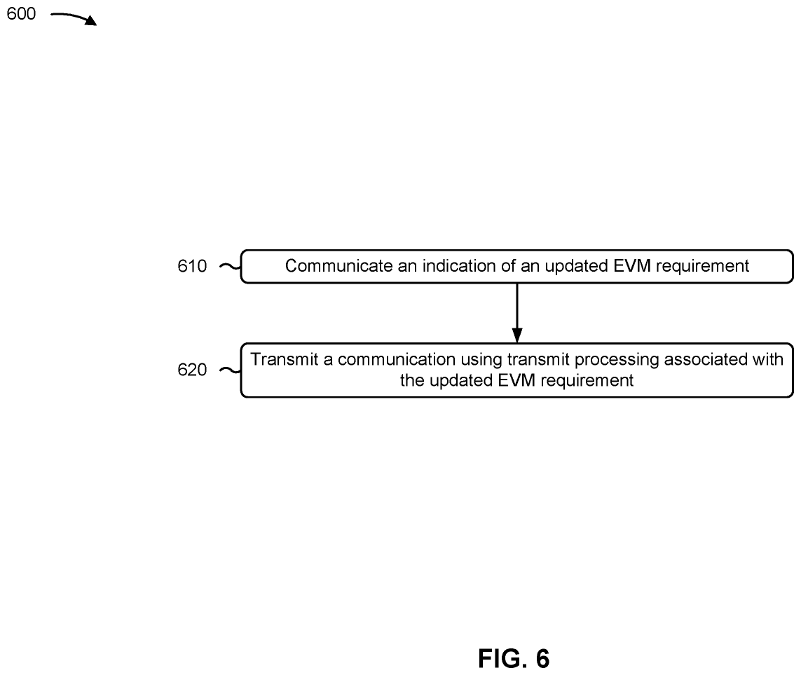

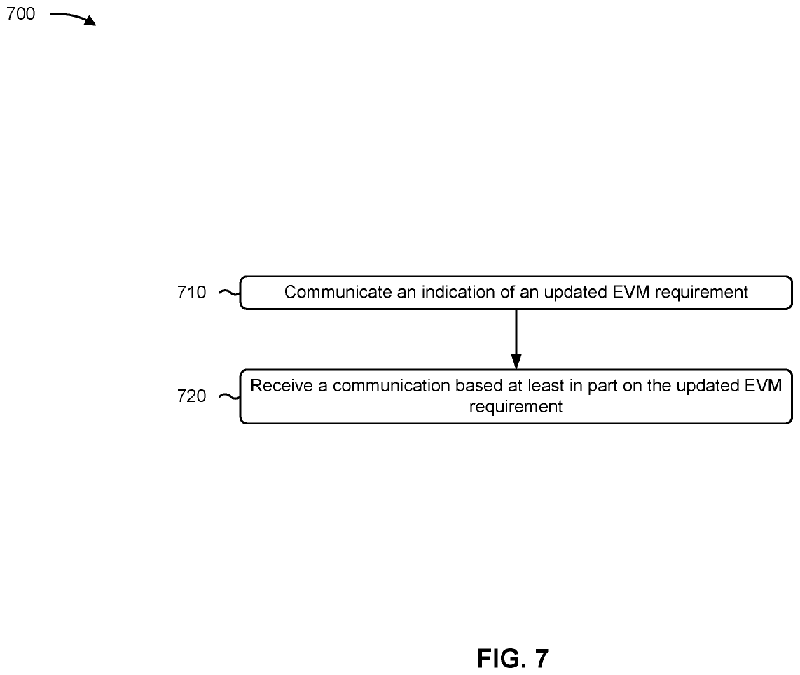

The controller/processor 240 of the base station 110, the controller/processor 280 of the UE 120, and/or any other component(s) of FIG. 2 may perform one or more techniques associated with EVM requirement updates, as described in more detail elsewhere herein. In some aspects, the transmitting device or the receiving device described herein is the base station 110, is included in the base station 110, or includes one or more components of the base station 110 shown in FIG. 2. In some aspects, the transmitting device or the receiving device described herein is the base station 110, is included in the base station 110, or includes one or more components of the base station 110 shown in FIG. 2, as described in more detail elsewhere herein. For example, the controller/processor 240 of the base station 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, the transmitting device includes means for communicating an indication of an updated EVM requirement; and/or means for transmitting a communication using transmit processing associated with the updated EVM requirement. In some aspects, the means for the transmitting device to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the transmitting device to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the receiving device includes means for communicating an indication of an updated EVM requirement; and/or means for receiving a communication based at least in part on the updated EVM requirement. In some aspects, the means for the receiving device to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the receiving device to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

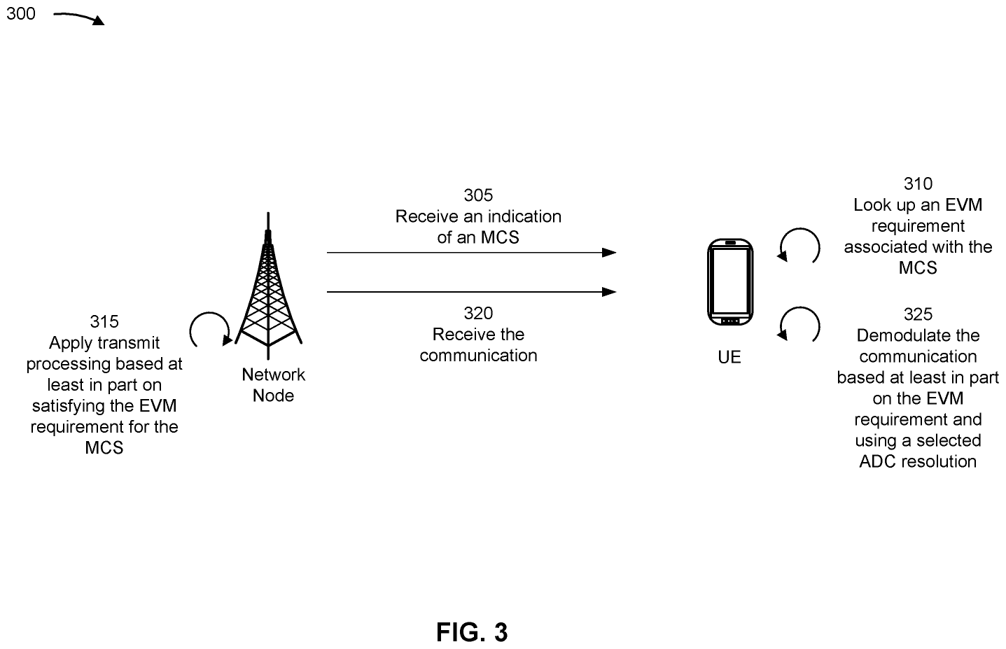

FIG. 3 is a diagram illustrating an example of communicating based at least in part on an EVM requirement, in accordance with the present disclosure. As shown in FIG. 3, a UE and a network node may communicate via a wireless network. The UE and the network node may have previously established a connection. The network node and the UE may have been configured with a set of EVM requirements associated with different MCSs. For example, the network node and the UE may be configured with a communication standard that defines the set of EVM requirements and maps the EVM requirements to various MCSs.

As shown by reference number 305, the UE may receive, and the network node may transmit, an indication of an MCS associated with a communication. For example, the MCS may indicate that the communication is to be modulated with a Pi/2 binary phase shift keying (BPSK), quadrature phase shift keying (QPSK), 16 quadrature amplitude modulation (QAM), 64 QAM, or 256 QAM, among other examples. Relatively high modulation schemes include a relatively high number of constellation points associated with different values, each of which carries a relatively high number of bits. For example, BPSK may carry 1 bit via selection of one of two constellation points, QPSK may carry 2 bits via selection of one of four constellation points, and 256 QAM may carry 8 bits via selection of one of 256 constellation points. Constellation points of the relatively high modulation schemes may have relatively small separation in an I/Q plane. For this reason, average error associated with locations of a transmitted signal may be required to be lower for relatively high modulation schemes to reduce errors in demodulation of the signal via a receiving device.

As shown by reference number 310, the UE may look up an EVM requirement associated with the MCS. For example, the UE may identify the EVM requirement via the configured set of EVM requirements based at least in part on the MCS. In some networks, a required average EVM level may be 30% for BPSK, 17.5% for QPSK, 12.5% for 16 QAM, 8% for 64 QAM, or 3.5% for 256 QAM, among other examples.

As shown by reference number 315, the network node may apply transmit processing to signaling that is to carry the communication. The transmit processing is based at least in part on satisfying the EVM requirement associated with the MCS. For example, the network node may apply transmit processing to satisfy the EVM requirement by applying increased computing and power resources to generate the signaling with a relatively high EVM requirement.

As shown by reference number 320, the UE may receive, and the network node may transmit, the communication. For example, the network node may transmit the signaling that carries the communication, with the signaling having the transmit processing applied.

As shown by reference number 325, the UE may demodulate the communication based at least in part on the EVM requirement and using a selected analog to digital conversion (ADC) resolution. For example, the UE may assume that an EVM requirement is satisfied and may report to the network node if the signaling fails to satisfy the EVM requirement.

The UE may select an ADC resolution (e.g., a number of quantization bits per unit of time) based at least in part on power consumption parameters. For example, the UE may select a relatively low ADC resolution to conserve power resources. However, the relatively low ADC resolution may negatively affect an accuracy of measuring a sample of the signaling. Using the relatively low ADC resolution may cause a measurement of EVM to be higher than if using a relatively high ADC resolution.

Based at least in part on using a relatively low ADC resolution, the UE is more likely to report a failure to satisfy the EVM requirement. Based at least in part on receiving the report of the failure to satisfy the EVM requirement, the network node may apply increased computing and power resources to improve the EVM of a subsequent communication. However, the EVM of the subsequent communication may also fail to satisfy the EVM requirement based at least in part on the UE using the relatively low ADC resolution. In this way, the network node may unnecessarily consume computing and power resources to satisfy the EVM requirement when satisfaction is unlikely based at least in part on the UE using the relatively low ADC resolution.

As indicated above, FIG. 3 is provided as an example. Other examples may differ from what is described with regard to FIG. 3.

In some aspects described herein, a transmitting device (e.g., a network node or a UE) may communicate an indication of an updated EVM requirement. The transmitting device may transmit a communication using transmit processing associated with the updated EVM requirement. In some aspects, the transmitting device may communicate the indication of the updated EVM requirement by transmitting or receiving the indication of the updated EVM requirement. The transmitting device may communicate the updated EVM requirement with a receiving device or with a network device (e.g., a central unit or a mobility management entity). In some aspects, the indication of the updated EVM requirement may include, and/or may consist of, an indication of an ADC to be used by the receiving device. For example, the receiving device may transmit an indication of an ADC resolution that the receiving device is to use to receive the communication, and the transmitting device may determine the updated EVM based at least in part on the ADC resolution.

In some aspects, the updated EVM requirement may apply to all communications with the receiving device, only communications transmitted from the transmitting device, or only to a communication resource such as a time domain resource, a frequency domain, and/or a spatial domain, among other examples. In some aspects, the updated EVM requirement is associated with an MCS or may be associated with multiple MCSs (e.g., an increase for all EVM requirements for the multiple MCSs by an amount or by a percentage, among other examples).

In some aspects, the transmitting device may transmit the communication using transmit processing having parameters such as a transmit power, a beamwidth, a beamforming gain (e.g., based at least in part on the beamwidth), and/or a coding scheme, among other examples, to satisfy the EVM requirement. For example, the transmitting device may use transmit processing that, based at least in part on the updated EVM requirement, has increased or decreased transmit power, a beamwidth, a beamforming gain (e.g., based at least in part on the beamwidth), and/or a coding scheme that are configured to satisfy the EVM requirement. For example, based at least in part on the EVM requirement being higher (e.g., less strict), the network node may update a coding scheme to reduce errors in reception of the communication by the receiving device and/or to improve spectral efficiency of the communication.

Based at least in part on communicating an updated EVM requirement, a transmitting device may conserve computing and/or power resources that may have otherwise been consumed based at least in part on attempting to satisfy an EVM requirement that is based at least in part on a prior EVM requirement. Additionally, or alternatively, a receiving device may conserve power resources based at least in part on being able to use a relatively low ADC resolution without causing failures to satisfy the prior EVM requirement. Based at least in part on avoiding, or reducing, failures to satisfy the prior EVM requirement, the transmitting device and the receiving device may conserve network, communication, power, and/or computing resources that may have otherwise been consumed to communicate and attempt to correct the failures.

FIG. 4 is a diagram illustrating an example 400 associated with EVM requirement updates, in accordance with the present disclosure. As shown in FIG. 4, a network node (e.g., base station 110, a CU, a DU, and/or an RU, among other examples) may communicate with a UE (e.g., UE 120). In some aspects, the network node and the UE may be part of a wireless network (e.g., wireless network 100).

As shown by reference number 405, the network node may transmit, and the UE may receive, configuration information. In some aspects, the UE may receive the configuration information via one or more of radio resource control (RRC) signaling, medium access control (MAC) control elements (MAC CEs), and/or downlink control information (DCI), among other examples. In some aspects, the configuration information may include an indication of one or more configuration parameters (e.g., already known to the UE) for selection by the UE, and/or explicit configuration information for the UE to use to configure the UE, among other examples.

In some aspects, the configuration information may indicate that the UE is to transmit an indication of UE support for updating EVM requirements. In some aspects, the configuration information may indicate that the UE is transmit and/or receive requests and/or indications to use updated EVM requirements. In some aspects, the configuration information may indicate a configuration for how the UE may transmit and/or receive the requests or indications to use the updated EVM requirements.

As shown by reference number 410, the UE may configure the UE based at least in part on the configuration information. In some aspects, the UE may be configured to perform one or more operations described herein based at least in part on the configuration information.

As shown by reference number 415, the UE may transmit, and the network node may receive, an indication of UE support for updating EVM requirements. In some aspects, the UE may indicate EVM requirements supported and/or ADC resolutions supported by the UE.

As shown by reference number 420, the UE may receive, and the network node may transmit, a request to use an updated EVM requirement. In some aspects, the request to use the updated EVM requirement may be associated with a request to use the updated EVM requirement for a communication resource of a communication channel used to transmit a communication. The communication resource may include a time domain resource (e.g., a number of slots, subframes, frames, or milliseconds, among other examples), a frequency domain (e.g., a defined bandwidth or one or more bandwidth parts, among other examples), and/or a spatial domain (e.g., one or more beams), among other examples. In some aspects, the request to use the updated EVM requirement is associated with an MCS or multiple MCSs. In some aspects, the request to use the updated EVM requirement is based at least in part on a UE class of the UE and/or a network node type (e.g., base station type) of the network node.

In some aspects, the request to use the updated EVM requirement may include, or may consist of, a request for the UE to use an ADC resolution for receiving the communication.

As shown by reference number 425, the UE may transmit, and the network node may receive, an indication to use the updated EVM requirement. In some aspects, the network node may receive the indication to use the updated EVM requirement via a network device, such as a central unit or a mobility management entity, among other examples. In some aspects, the UE may transmit the indication to use the updated EVM requirement via a network device, such as a central unit or a mobility management entity (e.g., via a different network node), among other examples.

In some aspects, the UE may transmit the indication to use the updated EVM based at least in part on the request to use the updated EVM requirement. In some aspects, the UE may transmit the indication to use the updated EVM independently from (e.g., in the absence of) the request to use the updated EVM requirement.

In some aspects, the indication to use the updated EVM may be associated with an indication to use the updated EVM requirement for a communication resource of a communication channel used to transmit a communication. The communication resource may include a time domain resource, a frequency domain, and/or a spatial domain, among other examples. In some aspects, the indication to use the updated EVM requirement is associated with an MCS or multiple MCSs. In some aspects, the indication to use the updated EVM requirement is based at least in part on a UE class of the UE and/or a network node type of the network node.

In some aspects, the indication to use the updated EVM requirement may include, or may consist of, an indication that the UE is to use an ADC resolution for receiving the communication.

In some aspects, the UE may select the updated EVM requirement to be the same as the updated EVM requirement indicated in the request to use the updated EVM requirement. In some aspects, the UE may select the updated EVM requirement to be associated with, but not necessarily the same as, the updated EVM requirement indicated in the request to use the updated EVM requirement.

As shown by reference number 430, the UE may transmit, and the network node may receive, a request to use the updated EVM requirement. In some aspects, the request to use the updated EVM may be associated with a request to use the updated EVM requirement for a communication resource of a communication channel used to transmit a communication. The communication resource may include a time domain resource, a frequency domain, and/or a spatial domain, among other examples. In some aspects, the request to use the updated EVM requirement is associated with an MCS or multiple MCSs. In some aspects, the request to use the updated EVM requirement is based at least in part on a UE class of the UE and/or a network node type of the network node.

In some aspects, the request to use the updated EVM requirement may include, or may consist of, an indication that the UE is to use an ADC resolution for receiving the communication.

As shown by reference number 435, the network node may select the updated EVM requirement. In some aspects, the network node may select the updated EVM requirement based at least in part on an ADC resolution to be used by the UE, as indicated in an indication or request to use the updated EVM requirement. In some aspects, the network node may select the updated EVM requirement based at least in part on a mapping from the ADC resolution to the updated EVM requirement.

In some aspects, the network node may select the updated EVM requirement to be the same as the updated EVM requirement indicated in the indication to use the updated EVM requirement or the request to use the updated EVM requirement. In some aspects, the network node may select the updated EVM requirement to be associated with, but not necessarily the same as, the updated EVM requirement indicated in the indication to use the updated EVM requirement or the request to use the updated EVM requirement.

As shown by reference number 440, the UE may receive, and the network node may transmit, an indication to use the updated EVM requirement. In some aspects, the UE may receive the indication to use the updated EVM requirement via a network device, such as a central unit or a mobility management entity, among other examples. In some aspects, the network node may transmit the indication to use the updated EVM requirement via a network device, such as a central unit or a mobility management entity, among other examples.

In some aspects, the indication to use the updated EVM may be associated with a request to use the updated EVM requirement for a communication resource of a communication channel used to transmit a communication. The communication resource may include a time domain resource, a frequency domain, and/or a spatial domain, among other examples. In some aspects, the indication to use the updated EVM requirement is associated with an MCS or multiple MCSs. In some aspects, the indication to use the updated EVM requirement is based at least in part on a UE class of the UE and/or a network node type of the network node.

In some aspects, the indication to use the updated EVM requirement may include, or may consist of, an indication that the UE is to use an ADC resolution for receiving the communication.

In some aspects, the network node may transmit the indication to use the updated EVM requirement in the absence of the request described in connection with reference number 420 and/or in the absence of the indication described in connection with reference number 425.

As shown by reference number 445, the UE may receive, and the network node may transmit, a resource allocation and/or an MCS for the communication. In some aspects, the resource allocation may include an indication of the MCS for the communication. In some aspects, the resource allocation may indicate that resources to be used for the communication include a communication resource associated with the indication to use the EVM requirement (e.g., as described in connection with reference number 425 and/or 440).

As shown by reference number 450, the UE may receive, and the network node may transmit, the communication. In some aspects, the network node may transmit the communication using transmit processing associated with the updated EVM requirement. In some aspects, the network node may transmit the communication using transmit processing associated with the updated EVM by applying one or more transmit parameters, such as an updated transmit power, an updated bandwidth, an updated beamforming gain, and/or an updated coding scheme, among other examples, based at least in part on the updated EVM requirement. In some aspects, the network node may receive (e.g., from the network entity) an indication to use the parameters to transmit the communication based at least in part on the updated EVM requirement.

As shown by reference number 455, the UE may apply an ADC associated with the EVM requirement to demodulate the communication. For example, the UE may apply a relatively low ADC to conserve power resources of the UE. In some aspects, the UE may transmit a report based at least in part on whether the communication satisfied the updated EVM requirement.

Based at least in part on communicating an updated EVM requirement, the network node may conserve computing and/or power resources that may have otherwise been consumed based at least in part on attempting to satisfy an EVM requirement that is based at least in part on a prior EVM requirement. Additionally, or alternatively, the UE may conserve power resources based at least in part on being able to use a relatively low ADC resolution without causing failures to satisfy the prior EVM requirement. Based at least in part on avoiding, or reducing, failures to satisfy the prior EVM requirement, the network node and the UE may conserve network, communication, power, and/or computing resources that may have otherwise been consumed to communicate and attempt to correct the failures.

As indicated above, FIG. 4 is provided as an example. Other examples may differ from what is described with regard to FIG. 4.

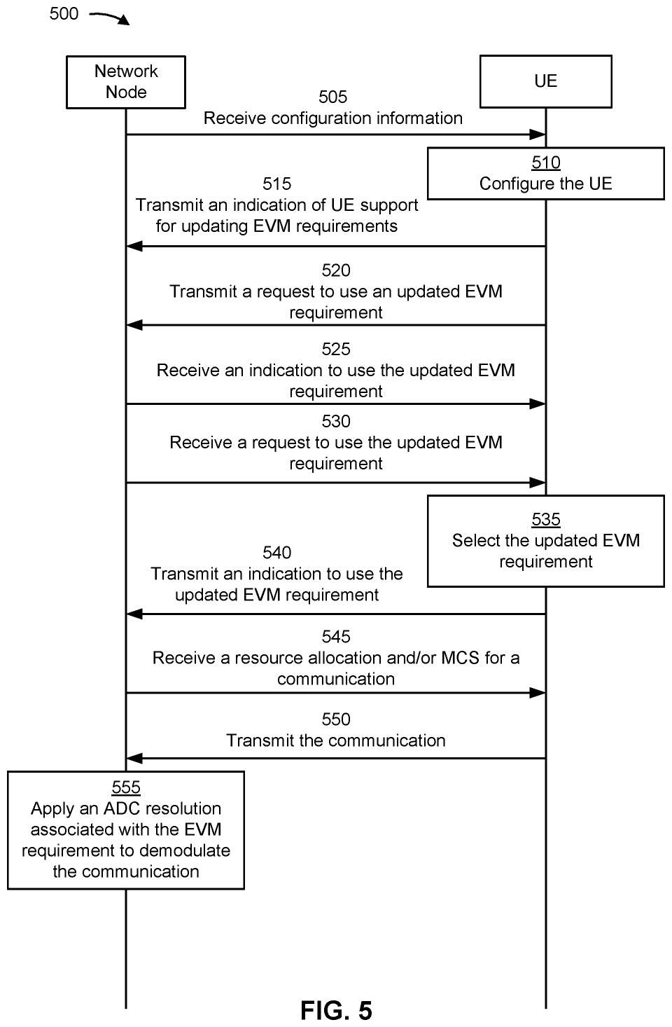

FIG. 5 is a diagram illustrating an example 500 associated with EVM requirement updates, in accordance with the present disclosure. As shown in FIG. 5, a network node (e.g., base station 110, a CU, a DU, and/or an RU, among other examples) may communicate with a UE (e.g., UE 120). In some aspects, the network node and the UE may be part of a wireless network (e.g., wireless network 100).

As shown by reference number 505, the network node may transmit, and the UE may receive, configuration information. In some aspects, the UE may receive the configuration information via one or more of RRC signaling, MAC CEs, and/or DCI, among other examples. In some aspects, the configuration information may include an indication of one or more configuration parameters (e.g., already known to the UE) for selection by the UE, and/or explicit configuration information for the UE to use to configure the UE, among other examples.

In some aspects, the configuration information may indicate that the UE is to transmit an indication of UE support for updating EVM requirements. In some aspects, the configuration information may indicate that the UE is transmit and/or receive requests and/or indications to use updated EVM requirements. In some aspects, the configuration information may indicate a configuration for how the UE may transmit and/or receive the requests or indications to use the updated EVM requirements.

As shown by reference number 510, the UE may configure the UE based at least in part on the configuration information. In some aspects, the UE may be configured to perform one or more operations described herein based at least in part on the configuration information.

As shown by reference number 515, the UE may transmit, and the network node may receive, an indication of UE support for updating EVM requirements. In some aspects, the UE may indicate EVM requirements supported and/or ADC resolutions supported by the network node.

As shown by reference number 520, the UE may transmit, and the network node may receive, a request to use an updated EVM requirement. In some aspects, the request to use the updated EVM may be associated with a request to use the updated EVM requirement for a communication resource of a communication channel used to transmit a communication. The communication resource may include a time domain resource, a frequency domain, and/or a spatial domain, among other examples. In some aspects, the request to use the updated EVM requirement is associated with an MCS or multiple MCSs. In some aspects, the request to use the updated EVM requirement is based at least in part on a UE class of the UE and/or a network node type of the network node.

In some aspects, the request to use the updated EVM requirement may include, or may consist of, a request for the network node to use an ADC resolution for receiving the communication.

As shown by reference number 525, the UE may receive, and the network node may transmit, an indication to use the updated EVM requirement. In some aspects, the UE may receive the indication to use the updated EVM requirement via a network device, such as a central unit or a mobility management entity, among other examples. In some aspects, the UE may receive the indication to use the updated EVM requirement via a network device, such as a central unit or a mobility management entity (e.g., via a different network node), among other examples.

In some aspects, the network node may transmit the indication to use the updated EVM based at least in part on the request to use the updated EVM requirement. In some aspects, the network node may transmit the indication to use the updated EVM independently from (e.g., in the absence of) the request to use the updated EVM requirement.

In some aspects, the indication to use the updated EVM may be associated with an indication to use the updated EVM requirement for a communication resource of a communication channel used to transmit a communication. The communication resource may include a time domain resource, a frequency domain, and/or a spatial domain, among other examples. In some aspects, the indication to use the updated EVM requirement is associated with an MCS or multiple MCSs. In some aspects, the indication to use the updated EVM requirement is based at least in part on a UE class of the UE and/or a network node type of the network node.

In some aspects, the indication to use the updated EVM requirement may include, or may consist of, an indication that the network node is to use an ADC resolution for receiving the communication.

In some aspects, the network node may select the updated EVM requirement to be the same as the updated EVM requirement indicated in the request to use the updated EVM requirement. In some aspects, the network node may select the updated EVM requirement to be associated with, but not necessarily the same as, the updated EVM requirement indicated in the request to use the updated EVM requirement.

As shown by reference number 530, the UE may receive, and the network node may transmit, a request to use the updated EVM requirement. In some aspects, the request to use the updated EVM may be associated with a request to use the updated EVM requirement for a communication resource of a communication channel used to transmit a communication. The communication resource may include a time domain resource, a frequency domain, and/or a spatial domain, among other examples. In some aspects, the request to use the updated EVM requirement is associated with an MCS or multiple MCSs. In some aspects, the request to use the updated EVM requirement is based at least in part on a UE class of the UE and/or a network node type of the network node.

In some aspects, the request to use the updated EVM requirement may include, or may consist of, an indication that the network node is to use an ADC resolution for receiving the communication.

As shown by reference number 535, the UE may select the updated EVM requirement. In some aspects, the UE may select the updated EVM requirement based at least in part on an ADC resolution to be used by the network node, as indicated in an indication or request to use the updated EVM requirement. In some aspects, the UE may select the updated EVM requirement based at least in part on a mapping from the ADC resolution to the updated EVM requirement.

In some aspects, the UE may select the updated EVM requirement to be the same as the updated EVM requirement indicated in the indication to use the updated EVM requirement or the request to use the updated EVM requirement. In some aspects, the UE may select the updated EVM requirement to be associated with, but not necessarily the same as, the updated EVM requirement indicated in the indication to use the updated EVM requirement or the request to use the updated EVM requirement.

As shown by reference number 540, the UE may transmit, and the network node may receive, an indication to use the updated EVM requirement. In some aspects, the network node may receive the indication to use the updated EVM requirement via a network device, such as a central unit or a mobility management entity, among other examples. In some aspects, the UE may transmit the indication to use the updated EVM requirement via a network device, such as a central unit or a mobility management entity, among other examples.

In some aspects, the indication to use the updated EVM may be associated with a request to use the updated EVM requirement for a communication resource of a communication channel used to transmit a communication. The communication resource may include a time domain resource, a frequency domain, and/or a spatial domain, among other examples. In some aspects, the indication to use the updated EVM requirement is associated with an MCS or multiple MCSs. In some aspects, the indication to use the updated EVM requirement is based at least in part on a UE class of the UE and/or a network node type of the network node.

In some aspects, the indication to use the updated EVM requirement may include, or may consist of, an indication that the network node is to use an ADC resolution for receiving the communication.

In some aspects, the UE may transmit the indication to use the updated EVM requirement in the absence of the request described in connection with reference number 520 and/or in the absence of the indication described in connection with reference number 525.

As shown by reference number 545, the UE may receive, and the network node may transmit, a resource allocation and/or an MCS for the communication. In some aspects, the resource allocation may include an indication of the MCS for the communication. In some aspects, the resource allocation may indicate that resources to be used for the communication include a communication resource associated with the indication to use the EVM requirement (e.g., as described in connection with reference number 525 and/or 540).

As shown by reference number 550, the UE may transmit, and the network node may receive, the communication. In some aspects, the UE may transmit the communication using transmit processing associated with the updated EVM requirement. In some aspects, the UE may apply one or more parameters, such as an updated transmit power, an updated bandwidth, an updated beamforming gain, and/or an updated coding scheme, among other examples, based at least in part on the updated EVM requirement. In some aspects, the UE may receive (e.g., from the network entity or the network node, among other examples) an indication to use the parameters to transmit the communication based at least in part on the updated EVM requirement.

As shown by reference number 555, the network node may apply an ADC associated with the EVM requirement to demodulate the communication. For example, the network node may apply a relatively low ADC to conserve power resources of the network node. In some aspects, the network node may transmit a report based at least in part on whether the communication satisfied the updated EVM requirement.

Based at least in part on communicating an updated EVM requirement, the UE may conserve computing and/or power resources that may have otherwise been consumed based at least in part on attempting to satisfy an EVM requirement that is based at least in part on a prior EVM requirement. Additionally, or alternatively, the network node may conserve power resources based at least in part on being able to use a relatively low ADC resolution without causing failures to satisfy the prior EVM requirement. Based at least in part on avoiding, or reducing, failures to satisfy the prior EVM requirement, the network node and the UE may conserve network, communication, power, and/or computing resources that may have otherwise been consumed to communicate and attempt to correct the failures.

As indicated above, FIG. 5 is provided as an example. Other examples may differ from what is described with regard to FIG. 5.

FIG. 6 is a diagram illustrating an example process 600 performed, for example, by a transmitting device, in accordance with the present disclosure. Example process 600 is an example where the transmitting device (e.g., base station 110, a CU, a DU, and/or an RU, among other examples or UE 120) performs operations associated with error vector magnitude requirement updates.

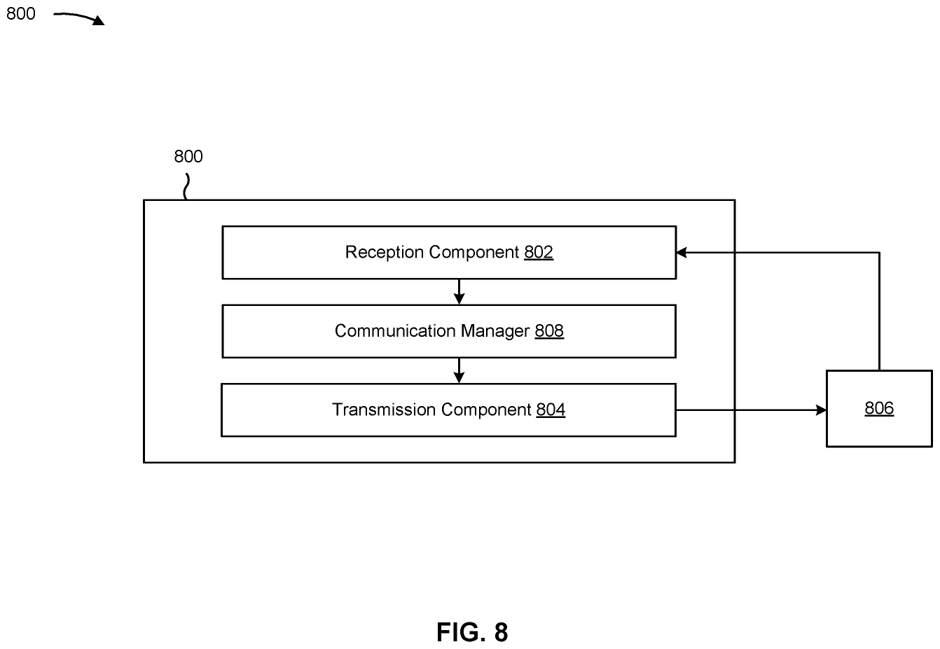

As shown in FIG. 6, in some aspects, process 600 may include communicating an indication of an updated EVM requirement (block 610). For example, the transmitting device (e.g., using communication manager 140 or 150, reception component 802, and/or transmission component 804, depicted in FIG. 8) may communicate an indication of an updated EVM requirement, as described above.

As further shown in FIG. 6, in some aspects, process 600 may include transmitting a communication using transmit processing associated with the updated EVM requirement (block 620). For example, the transmitting device (e.g., using communication manager 140 or 150 and/or transmission component 804, depicted in FIG. 8) may transmit a communication using transmit processing associated with the updated EVM requirement, as described above.

Process 600 may include additional aspects, such as any single aspect or any combination of aspects described below and/or in connection with one or more other processes described elsewhere herein.

In a first aspect, communicating the indication of the updated EVM requirement comprises one or more of transmitting an indication to use the updated EVM requirement, or receiving the indication to use the updated EVM requirement.

In a second aspect, alone or in combination with the first aspect, receiving the indication to use the updated EVM requirement comprises receiving the indication to use the updated EVM requirement via one or more of a receiving device, or a network device.

In a third aspect, alone or in combination with one or more of the first and second aspects, transmitting the indication to use the updated EVM requirement comprises transmitting the indication to use the updated EVM requirement to one or more of a receiving device, or a network device.

In a fourth aspect, alone or in combination with one or more of the first through third aspects, the updated EVM requirement is associated with a communication resource of a communication channel used to transmit the communication.

In a fifth aspect, alone or in combination with one or more of the first through fourth aspects, the communication resource comprises one or more of a time domain resource, a frequency domain resource, or a spatial domain resource.

In a sixth aspect, alone or in combination with one or more of the first through fifth aspects, the updated EVM requirement is associated with a modulation scheme used to transmit the communication.

In a seventh aspect, alone or in combination with one or more of the first through sixth aspects, the updated EVM requirement is associated with one or more of a network node type of the transmitting device, a network node type of a receiving device, a UE class of the transmitting device, or a UE class of the receiving device.

In an eighth aspect, alone or in combination with one or more of the first through seventh aspects, process 600 includes transmitting a request to use the updated EVM, wherein communicating the indication of the updated EVM requirement comprises receiving, based at least in part on the request, an indication to use the updated EVM requirement.

In a ninth aspect, alone or in combination with one or more of the first through eighth aspects, transmitting the request to use the updated EVM comprises transmitting the request to one or more of a receiving device or a network device.

In a tenth aspect, alone or in combination with one or more of the first through ninth aspects, process 600 includes receiving a request to use the updated EVM, wherein communicating the indication of the updated EVM requirement comprises transmitting, based at least in part on the request, an indication to use the updated EVM requirement.

In an eleventh aspect, alone or in combination with one or more of the first through tenth aspects, receiving the request to use the updated EVM comprises receiving the request from one or more of a receiving device or a network device.

In a twelfth aspect, alone or in combination with one or more of the first through eleventh aspects, communicating the indication of the updated EVM requirement comprises one or more of transmitting an indication to perform an analog to digital conversion using an updated resolution associated with the updated EVM requirement, or receiving an indication to perform a digital to analog conversion using the updated resolution associated with the updated EVM requirement.

In a thirteenth aspect, alone or in combination with one or more of the first through twelfth aspects, transmitting the communication using the transmit processing associated with the updated EVM requirement comprises transmitting the communication using parameters that include one or more of an updated transmit power, an updated beamwidth an updated beamforming gain, or an updated coding scheme.

In a fourteenth aspect, alone or in combination with one or more of the first through thirteenth aspects, process 600 includes receiving an indication to use the parameters based at least in part on the updated EVM requirement.

In a fifteenth aspect, alone or in combination with one or more of the first through fourteenth aspects, communicating the indication of the updated EVM requirement comprises receiving an indication of an analog to digital conversion resolution to be used by a receiving device, and selecting the updated EVM requirement based at least in part on the analog to digital conversion resolution.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a receiving device, in accordance with the present disclosure. Example process 700 is an example where the receiving device (e.g., base station 110, a CU, a DU, and/or an RU, among other examples or UE 120) performs operations associated with error vector magnitude requirement updates.

As shown in FIG. 7, in some aspects, process 700 may include communicating an indication of an updated EVM requirement (block 710). For example, the receiving device (e.g., using communication manager 140 or 150, reception component 902, and/or transmission component 904, depicted in FIG. 9) may communicate an indication of an updated EVM requirement, as described above.

As further shown in FIG. 7, in some aspects, process 700 may include receiving a communication based at least in part on the updated EVM requirement (block 720). For example, the receiving device (e.g., using communication manager 140 or 150 and/or reception component 902, depicted in FIG. 9) may receive a communication based at least in part on the updated EVM requirement, as described above.

Process 700 may include additional aspects, such as any single aspect or any combination of aspects described below and/or in connection with one or more other processes described elsewhere herein.

In a first aspect, communicating the indication of the updated EVM requirement comprises one or more of transmitting an indication to use the updated EVM requirement, or receiving the indication to use the updated EVM requirement.

In a second aspect, alone or in combination with the first aspect, receiving the indication to use the updated EVM requirement comprises receiving the indication to use the updated EVM requirement via one or more of a transmitting device, or a network device.

In a third aspect, alone or in combination with one or more of the first and second aspects, transmitting the indication to use the updated EVM requirement comprises transmitting the indication to use the updated EVM requirement to one or more of a transmitting device, or a network device.

In a fourth aspect, alone or in combination with one or more of the first through third aspects, the updated EVM requirement is associated with a communication resource of a communication channel used to transmit the communication.

In a fifth aspect, alone or in combination with one or more of the first through fourth aspects, the communication resource comprises one or more of a time domain resource, a frequency domain resource, or a spatial domain resource.

In a sixth aspect, alone or in combination with one or more of the first through fifth aspects, the updated EVM requirement is associated with a modulation scheme used to transmit the communication.

In a seventh aspect, alone or in combination with one or more of the first through sixth aspects, the updated EVM requirement is associated with one or more of a network node type of a transmitting device, a network node type of the receiving device, a UE class of the transmitting device, or a UE class of the receiving device.

In an eighth aspect, alone or in combination with one or more of the first through seventh aspects, process 700 includes transmitting a request to use the updated EVM, wherein communicating the indication of the updated EVM requirement comprises receiving, based at least in part on the request, an indication to use the updated EVM requirement.

In a ninth aspect, alone or in combination with one or more of the first through eighth aspects, transmitting the request to use the updated EVM comprises transmitting the request to one or more of a transmitting device or a network device.

In a tenth aspect, alone or in combination with one or more of the first through ninth aspects, process 700 includes receiving a request to use the updated EVM, wherein communicating the indication of the updated EVM requirement comprises transmitting, based at least in part on the request, an indication to use the updated EVM requirement.

In an eleventh aspect, alone or in combination with one or more of the first through tenth aspects, receiving the request to use the updated EVM comprises receiving the request from one or more of a transmitting device or a network device.

In a twelfth aspect, alone or in combination with one or more of the first through eleventh aspects, communicating the indication of the updated EVM requirement comprises one or more of receiving an indication to perform an analog to digital conversion using an updated resolution associated with the updated EVM requirement, or transmitting an indication to perform a digital to analog conversion using the updated resolution associated with the updated EVM requirement.

In a thirteenth aspect, alone or in combination with one or more of the first through twelfth aspects, receiving the communication based at least in part on the updated EVM requirement comprises receiving the communication using parameters that include one or more of an updated beamwidth, or an updated coding scheme.

In a fourteenth aspect, alone or in combination with one or more of the first through thirteenth aspects, process 700 includes receiving an indication to use the parameters based at least in part on the updated EVM requirement.

In a fifteenth aspect, alone or in combination with one or more of the first through fourteenth aspects, communicating the indication of the updated EVM requirement comprises transmitting an indication of an analog to digital conversion resolution to be used by the receiving device, and selecting the updated EVM requirement based at least in part on the analog to digital conversion resolution.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a transmitting device, or a transmitting device may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, a CU, a DU, and/or an RU, among other examples or another wireless communication device) using the reception component 802 and the transmission component 804. As further shown, the apparatus 800 may include a communication manager 808 (e.g., communication manager 140 or 150).

In some aspects, the apparatus 800 may be configured to perform one or more operations described herein in connection with FIGS. 4 and 5. Additionally, or alternatively, the apparatus 800 may be configured to perform one or more processes described herein, such as process 600 of FIG. 6. In some aspects, the apparatus 800 and/or one or more components shown in FIG. 8 may include one or more components of the transmitting device described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the transmitting device described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the transmitting device described in connection with FIG. 2. In some aspects, the transmission component 804 may be co-located with the reception component 802 in a transceiver.

The reception component 802 and/or the transmission component 804 may communicate an indication of an updated EVM requirement. The transmission component 804 may transmit a communication using transmit processing associated with the updated EVM requirement.

The transmission component 804 may transmit a request to use the updated EVM, wherein communicating the indication of the updated EVM requirement comprises receiving, based at least in part on the request, an indication to use the updated EVM requirement.

The reception component 802 may receive a request to use the updated EVM, wherein communicating the indication of the updated EVM requirement comprises transmitting, based at least in part on the request, an indication to use the updated EVM requirement.

The reception component 802 may receive an indication to use the parameters based at least in part on the updated EVM requirement.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a receiving device, or a receiving device may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, a CU, a DU, and/or an RU, among other examples or another wireless communication device) using the reception component 902 and the transmission component 904. As further shown, the apparatus 900 may include the communication manager 908 (e.g., communication manager 140 or 150).

In some aspects, the apparatus 900 may be configured to perform one or more operations described herein in connection with FIG. 4 or 5. Additionally, or alternatively, the apparatus 900 may be configured to perform one or more processes described herein, such as process 700 of FIG. 7. In some aspects, the apparatus 900 and/or one or more components shown in FIG. 9 may include one or more components of the receiving device described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the receiving device described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the receiving device described in connection with FIG. 2. In some aspects, the transmission component 904 may be co-located with the reception component 902 in a transceiver.

The reception component 902 and/or the transmission component 904 may communicate an indication of an updated EVM requirement. The reception component 902 may receive a communication based at least in part on the updated EVM requirement.

The transmission component 904 may transmit a request to use the updated EVM, wherein communicating the indication of the updated EVM requirement comprises receiving, based at least in part on the request, an indication to use the updated EVM requirement.

The reception component 902 may receive a request to use the updated EVM, wherein communicating the indication of the updated EVM requirement comprises transmitting, based at least in part on the request, an indication to use the updated EVM requirement.

The reception component 902 may receive an indication to use the parameters based at least in part on the updated EVM requirement.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

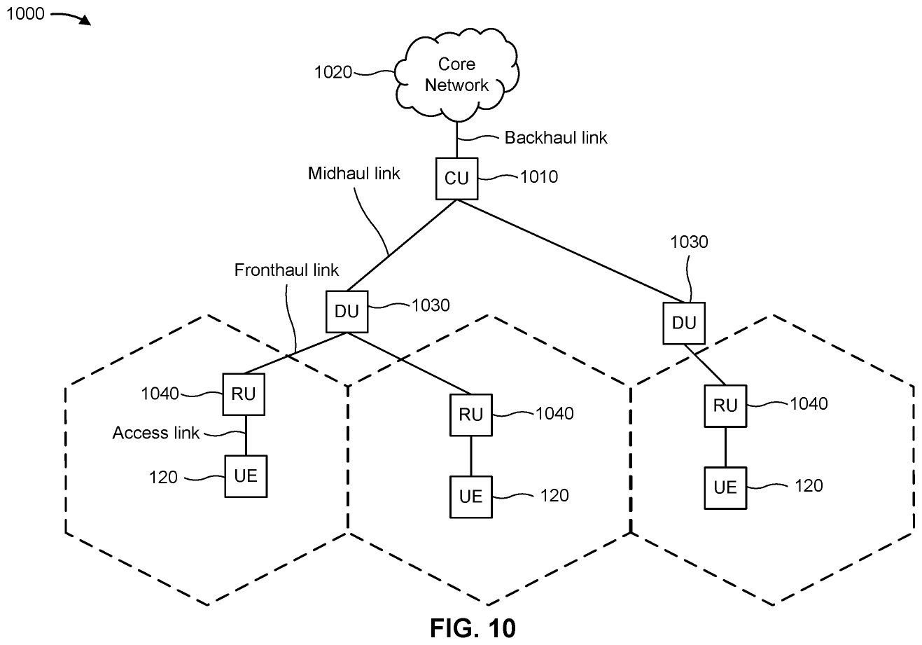

FIG. 10 is a diagram illustrating an example 1000 of an open RAN (O-RAN) architecture, in accordance with the present disclosure. As shown in FIG. 10, the O-RAN architecture may include a CU 1010 that communicates with a core network 1020 via a backhaul link. Furthermore, the CU 1010 may communicate with one or more DUs 1030 via respective midhaul links. The DUs 1030 may each communicate with one or more RUs 1040 via respective fronthaul links, and the RUs 1040 may each communicate with respective UEs 120 via RF access links. The DUs 1030 and the RUs 1040 may also be referred to as O-RAN DUs (O-DUs) 1030 and O-RAN RUs (O-RUs) 1040, respectively.

In some aspects, the DUs 1030 and the RUs 1040 may be implemented according to a functional split architecture in which functionality of a base station 110 (e.g., an eNB or a gNB) is provided by a DU 1030 and one or more RUs 1040 that communicate over a fronthaul link. Accordingly, as described herein, a base station 110 may include a DU 1030 and one or more RUs 1040 that may be co-located or geographically distributed. In some aspects, the DU 1030 and the associated RU(s) 1040 may communicate via a fronthaul link to exchange real-time control plane information via a lower layer split (LLS) control plane (LLS-C) interface, to exchange non-real-time management information via an LLS management plane (LLS-M) interface, and/or to exchange user plane information via an LLS user plane (LLS-U) interface.

Accordingly, the DU 1030 may correspond to a logical unit that includes one or more base station functions to control the operation of one or more RUs 1040. For example, in some aspects, the DU 1030 may host a radio link control (RLC) layer, a MAC layer, and one or more high physical (PHY) layers (e.g., forward error correction (FEC) encoding and decoding, scrambling, and/or modulation and demodulation) based at least in part on a lower layer functional split. Higher layer control functions, such as a packet data convergence protocol (PDCP), RRC, and/or service data adaptation protocol (SDAP), may be hosted by the CU 1010. The RU(s) 1040 controlled by a DU 1030 may correspond to logical nodes that host RF processing functions and low-PHY layer functions (e.g., fast Fourier transform (FFT), inverse FFT (iFFT), digital beamforming, and/or physical random access channel (PRACH) extraction and filtering) based at least in part on the lower layer functional split. Accordingly, in an O-RAN architecture, the RU(s) 1040 handle all over the air (OTA) communication with a UE 120, and real-time and non-real-time aspects of control and user plane communication with the RU(s) 1040 are controlled by the corresponding DU 1030, which enables the DU(s) 1030 and the CU 1010 to be implemented in a cloud-based RAN architecture.

As indicated above, FIG. 10 is provided as an example. Other examples may differ from what is described with regard to FIG. 10.

The following provides an overview of some Aspects of the present disclosure:

Aspect 1: A method of wireless communication performed by a transmitting device, comprising: communicating an indication of an updated error vector magnitude (EVM) requirement; and transmitting a communication using transmit processing associated with the updated EVM requirement.

Aspect 2: The method of Aspect 1, wherein communicating the indication of the updated EVM requirement comprises one or more of: transmitting an indication to use the updated EVM requirement, or receiving the indication to use the updated EVM requirement.

Aspect 3: The method of Aspect 2, wherein receiving the indication to use the updated EVM requirement comprises receiving the indication to use the updated EVM requirement via one or more of: a receiving device, or a network device.

Aspect 4: The method of Aspect 2, wherein transmitting the indication to use the updated EVM requirement comprises transmitting the indication to use the updated EVM requirement to one or more of: a receiving device, or a network device.

Aspect 5: The method of any of Aspects 1-4, wherein the updated EVM requirement is associated with a communication resource of a communication channel used to transmit the communication.

Aspect 6: The method of Aspect 5, wherein the communication resource comprises one or more of: a time domain resource, a frequency domain resource, or a spatial domain resource.

Aspect 7: The method of any of Aspects 1-6, wherein the updated EVM requirement is associated with a modulation scheme used to transmit the communication.

Aspect 8: The method of any of Aspects 1-7, wherein the updated EVM requirement is associated with one or more of: a network node type of the transmitting device, a network node type of a receiving device, a user equipment (UE) class of the transmitting device, or a UE class of the receiving device.

Aspect 9: The method of any of Aspects 1-8, further comprising transmitting a request to use the updated EVM, wherein communicating the indication of the updated EVM requirement comprises receiving, based at least in part on the request, an indication to use the updated EVM requirement.

Aspect 10: The method of Aspect 9, wherein transmitting the request to use the updated EVM comprises: transmitting the request to one or more of a receiving device or a network device.

Aspect 11: The method of any of Aspects 1-10, further comprising receiving a request to use the updated EVM, wherein communicating the indication of the updated EVM requirement comprises transmitting, based at least in part on the request, an indication to use the updated EVM requirement.

Aspect 12: The method of Aspect 11, wherein receiving the request to use the updated EVM comprises: receiving the request from one or more of a receiving device or a network device.

Aspect 13: The method of any of Aspects 1-12, wherein communicating the indication of the updated EVM requirement comprises one or more of: transmitting an indication to perform an analog to digital conversion using an updated resolution associated with the updated EVM requirement, or receiving an indication to perform a digital to analog conversion using the updated resolution associated with the updated EVM requirement.

Aspect 14: The method of any of Aspects 1-13, wherein transmitting the communication using the transmit processing associated with the updated EVM requirement comprises: transmitting the communication using parameters that include one or more of: an updated transmit power, an updated beamwidth an updated beamforming gain, or an updated coding scheme.

Aspect 15: The method of Aspect 14, further comprising: receiving an indication to use the parameters based at least in part on the updated EVM requirement.

Aspect 16: The method of Aspect 1, wherein communicating the indication of the updated EVM requirement comprises: receiving an indication of an analog to digital conversion resolution to be used by a receiving device, and selecting the updated EVM requirement based at least in part on the analog to digital conversion resolution.

Aspect 17: A method of wireless communication performed by a receiving device, comprising: communicating an indication of an updated error vector magnitude (EVM) requirement; and receiving a communication based at least in part on the updated EVM requirement.

Aspect 18: The method of Aspect 17, wherein communicating the indication of the updated EVM requirement comprises one or more of: transmitting an indication to use the updated EVM requirement, or receiving the indication to use the updated EVM requirement.

Aspect 19: The method of Aspect 18, wherein receiving the indication to use the updated EVM requirement comprises receiving the indication to use the updated EVM requirement via one or more of: a transmitting device, or a network device.

Aspect 20: The method of Aspect 18, wherein transmitting the indication to use the updated EVM requirement comprises transmitting the indication to use the updated EVM requirement to one or more of: a transmitting device, or a network device.

Aspect 21: The method of any of Aspects 17-20, wherein the updated EVM requirement is associated with a communication resource of a communication channel used to transmit the communication.

Aspect 22: The method of Aspect 21, wherein the communication resource comprises one or more of: a time domain resource, a frequency domain resource, or a spatial domain resource.

Aspect 23: The method of any of Aspects 17-22, wherein the updated EVM requirement is associated with a modulation scheme used to transmit the communication.

Aspect 24: The method of any of Aspects 17-23, wherein the updated EVM requirement is associated with one or more of: a network node type of a transmitting device, a network node type of the receiving device, a user equipment (UE) class of the transmitting device, or a UE class of the receiving device.

Aspect 25: The method of any of Aspects 17-24, further comprising transmitting a request to use the updated EVM, wherein communicating the indication of the updated EVM requirement comprises receiving, based at least in part on the request, an indication to use the updated EVM requirement.

Aspect 26: The method of Aspect 25, wherein transmitting the request to use the updated EVM comprises: transmitting the request to one or more of a transmitting device or a network device.

Aspect 27: The method of any of Aspects 17-26, further comprising receiving a request to use the updated EVM, wherein communicating the indication of the updated EVM requirement comprises transmitting, based at least in part on the request, an indication to use the updated EVM requirement.

Aspect 28: The method of Aspect 27, wherein receiving the request to use the updated EVM comprises: receiving the request from one or more of a transmitting device or a network device.

Aspect 29: The method of any of Aspects 17-28, wherein communicating the indication of the updated EVM requirement comprises one or more of: receiving an indication to perform an analog to digital conversion using an updated resolution associated with the updated EVM requirement, or transmitting an indication to perform a digital to analog conversion using the updated resolution associated with the updated EVM requirement.

Aspect 30: The method of any of Aspects 17-29, wherein receiving the communication based at least in part on the updated EVM requirement comprises one or more of: receiving the communication using parameters that include one or more of: an updated beamwidth, or an updated coding scheme.

Aspect 31: The method of Aspect 30, further comprising: receiving an indication to use the parameters based at least in part on the updated EVM requirement.

Aspect 32: The method of any of Aspects 17-31, wherein communicating the indication of the updated EVM requirement comprises: transmitting an indication of an analog to digital conversion resolution to be used by the receiving device, and selecting the updated EVM requirement based at least in part on the analog to digital conversion resolution.

Aspect 33: An apparatus for wireless communication at a device, comprising a processor; memory coupled with the processor; and instructions stored in the memory and executable by the processor to cause the apparatus to perform the method of one or more of Aspects 1-32.

Aspect 34: A device for wireless communication, comprising a memory and one or more processors coupled to the memory, the one or more processors configured to perform the method of one or more of Aspects 1-32.

Aspect 35: An apparatus for wireless communication, comprising at least one means for performing the method of one or more of Aspects 1-32.

Aspect 36: A non-transitory computer-readable medium storing code for wireless communication, the code comprising instructions executable by a processor to perform the method of one or more of Aspects 1-32.

Aspect 37: A non-transitory computer-readable medium storing a set of instructions for wireless communication, the set of instructions comprising one or more instructions that, when executed by one or more processors of a device, cause the device to perform the method of one or more of Aspects 1-32.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A transmitting device for wireless communication, comprising:
a memory; and
one or more processors, coupled to the memory, configured to:
communicate an indication of an updated error vector magnitude (EVM) requirement; and
transmit a communication using transmit processing associated with the updated EVM requirement.

2. The transmitting device of claim 1, wherein the one or more processors, to communicate the indication of the updated EVM requirement, are configured to:
transmit an indication to use the updated EVM requirement, or
receive the indication to use the updated EVM requirement.

3. The transmitting device of claim 2, wherein the one or more processors, to receive the indication to use the updated EVM requirement, are configured to receive the indication to use the updated EVM requirement via one or more of a receiving device or a network device, or
wherein the one or more processors, to transmit the indication to use the updated EVM requirement, are configured to transmit the indication to use the updated EVM requirement to one or more of a receiving device or a network device.

4. The transmitting device of claim 1, wherein the updated EVM requirement is associated with a communication resource of a communication channel used to transmit the communication, and
wherein the communication resource comprises one or more of:
a time domain resource,
a frequency domain resource, or
a spatial domain resource.

5. The transmitting device of claim 1, wherein the updated EVM requirement is associated with a modulation scheme used to transmit the communication.

6. The transmitting device of claim 1, wherein the updated EVM requirement is associated with one or more of:
a network node type of the transmitting device,
a network node type of a receiving device,
a user equipment (UE) class of the transmitting device, or
a UE class of the receiving device.

7. The transmitting device of claim 1, wherein the one or more processors are further configured to transmit a request to use the updated EVM requirement, and
wherein the one or more processors, to communicate the indication of the updated EVM requirement, are configured to receive, based at least in part on the request, an indication to use the updated EVM requirement.

8. The transmitting device of claim 1, wherein the one or more processors are further configured to receive a request to use the updated EVM requirement, and p1 wherein the one or more processors, to communicate the indication of the updated EVM requirement, are configured to transmit, based at least in part on the request, an indication to use the updated EVM requirement.

9. The transmitting device of claim 1, wherein the one or more processors, to communicate the indication of the updated EVM requirement, are configured to:
transmit an indication to perform an analog to digital conversion using an updated resolution associated with the updated EVM requirement, or
receive an indication to perform a digital to analog conversion using the updated resolution associated with the updated EVM requirement.

10. The transmitting device of claim 1, wherein the one or more processors, to transmit the communication using the transmit processing associated with the updated EVM requirement, are configured to:
transmit the communication using parameters that include one or more of:
an updated transmit power,
an updated beamwidth,
an updated beamforming gain, or
an updated coding scheme.

11. The transmitting device of claim 10, wherein the one or more processors are further configured to:
receive an indication to use the parameters based at least in part on the updated EVM requirement.

12. The transmitting device of claim 1, wherein the one or more processors, to communicate the indication of the updated EVM requirement, are configured to:
receive an indication of an analog to digital conversion resolution to be used by a receiving device, and
select the updated EVM requirement based at least in part on the analog to digital conversion resolution.

13. A receiving device for wireless communication, comprising:
a memory; and
one or more processors, coupled to the memory, configured to:
communicate an indication of an updated error vector magnitude (EVM) requirement; and
receive a communication based at least in part on the updated EVM requirement.

14. The receiving device of claim 13, wherein the one or more processors, to communicate the indication of the updated EVM requirement, are configured to:
transmit an indication to use the updated EVM requirement, or
receive the indication to use the updated EVM requirement.

15. The receiving device of claim 14, wherein the one or more processors, to receive the indication to use the updated EVM requirement, are configured to receive the indication to use the updated EVM requirement via one or more of transmitting device, or a network device, or
wherein the one or more processors, to transmit the indication to use the updated EVM requirement, are configured to transmit the indication to use the updated EVM requirement to one or more of a transmitting device or a network device.

16. The receiving device of claim 13, wherein the updated EVM requirement is associated with a communication resource of a communication channel used to transmit the communication, and
wherein the communication resource comprises one or more of:
a time domain resource,
a frequency domain resource, or
a spatial domain resource.

17. The receiving device of claim 13, wherein the updated EVM requirement is associated with a modulation scheme used to transmit the communication.

18. The receiving device of claim 13, wherein the updated EVM requirement is associated with one or more of:
a network node type of a transmitting device,
a network node type of the receiving device,
a user equipment (UE) class of the transmitting device, or
a UE class of the receiving device.

19. The receiving device of claim 13, wherein the one or more processors are further configured to transmit a request to use the updated EVM requirement, and
wherein the one or more processors, to communicate the indication of the updated EVM requirement, are configured to receive, based at least in part on the request, an indication to use the updated EVM requirement.

20. The receiving device of claim 13, wherein the one or more processors are further configured to receive a request to use the updated EVM requirement, and
wherein the one or more processors, to communicate the indication of the updated EVM requirement, are configured to transmit, based at least in part on the request, an indication to use the updated EVM requirement.

21. The receiving device of claim 13, wherein the one or more processors, to communicate the indication of the updated EVM requirement, are configured to:
receive an indication to perform an analog to digital conversion using an updated resolution associated with the updated EVM requirement, or
transmit an indication to perform a digital to analog conversion using the updated resolution associated with the updated EVM requirement.

22. The receiving device of claim 13, wherein the one or more processors, to receive the communication based at least in part on the updated EVM requirement, are configured to:
receive the communication using parameters that include one or more of:
an updated beamwidth, or
an updated coding scheme.

23. The receiving device of claim 22, wherein the one or more processors are further configured to:
receive an indication to use the parameters based at least in part on the updated EVM requirement.

24. The receiving device of claim 13, wherein the one or more processors, to communicate the indication of the updated EVM requirement, are configured to:
transmit an indication of an analog to digital conversion resolution to be used by the receiving device, and
select the updated EVM requirement based at least in part on the analog to digital conversion resolution.

25. A method of wireless communication performed by a transmitting device, comprising:
communicating an indication of an updated error vector magnitude (EVM) requirement; and
transmitting a communication using transmit processing associated with the updated EVM requirement.

26. The method of claim 25, wherein communicating the indication of the updated EVM requirement comprises one or more of:
transmitting an indication to use the updated EVM requirement, or
receiving the indication to use the updated EVM requirement.

27. The method of claim 25, wherein the updated EVM requirement is associated with one or more of:
a network node type of the transmitting device,
a network node type of a receiving device,
a user equipment (UE) class of the transmitting device, or
a UE class of the receiving device.

28. A method of wireless communication performed by a receiving device, comprising:
communicating an indication of an updated error vector magnitude (EVM) requirement; and
receiving a communication based at least in part on the updated EVM requirement.

29. The method of claim 28, wherein communicating the indication of the updated EVM requirement comprises one or more of:
transmitting an indication to use the updated EVM requirement, or
receiving the indication to use the updated EVM requirement.

30. The method of claim 28, wherein the updated EVM requirement is associated with one or more of:
a network node type of a transmitting device,
a network node type of the receiving device,
a user equipment (UE) class of the transmitting device, or
a UE class of the receiving device.
